(19) United States
(12) Patent Application Publication
(10) Pub. No.: US 2018/0010862 A1
(43) Pub. Date: Jan. 11, 2018

(54) ENCAPSULATED PHASE-CHANGE MATERIAL, THERMAL BATTERY AND ASSOCIATED PRODUCTION METHOD

(71) Applicant: Valeo Systemes Thermiques, Le Mesnil Saint-Denis (FR)

(72) Inventors: Samuel Bry, Laval (FR); Patrick Boisselle, Laval (FR); Kamel Azzouz, Le Mesnil Saint Denis (FR)

(73) Assignee: Valeo Systemes Thermiques, Le Mesnil Saint-Denis (FR)

(21) Appl. No.: 15/545,412

(22) PCT Filed: Jan. 26, 2016
(86) PCT No.: PCT/EP2016/051594

§ 371 Date: Jul. 21, 2017

(30) Foreign Application Priority Data
Jan. 26, 2015 (FR) 1550581

(51) Int. Cl. F28D 20/02; B29C 65/02; B29C 65/00; F28F 21/06; B29K 669/00; B29L 31/00

(52) U.S. Cl. CPC F28D 20/023; B29C 66/43121; B29C 66/433; F28F 21/06; B29C 65/02; B29C 66/73921; B29L 2031/7146; F28F 2275/06; B29K 2669/00

(57) ABSTRACT

The present invention relates to an encapsulated phase-change material (1) comprising a phase-change material (3) contained within a tube (5), said tube (5) being made of plastic and that it has a sealing weld (9) at least at one of its ends.

The present invention relates to the field of encapsulated phase-change materials, notably for thermal batteries.

Thermal batteries are generally used for heating the vehicle interior, notably in electric and hybrid vehicles or for preheating a heat-transfer fluid in a thermal management circuit. Thermal batteries may also be used for preheating the engine oil or the automatic transmission fluid of vehicles with an internal combustion engine.

A thermal battery with phase-change material generally comprises an enclosure forming a reservoir inside which the phase-change material is placed, generally in encapsulated form. The sealing of these encapsulations is important because a leak of phase-change material, for example in liquid form, reduces the effectiveness of the thermal battery but may also damage the components of the fluid circulation circuit.

One of the objects of the present invention is therefore to at least partially overcome the disadvantages of the prior art and to propose an improved encapsulated phase-change material.

The present invention therefore relates to an encapsulated phase-change material comprising a phase-change material contained within a tube, said tube being made of plastic and having a sealing weld at least at one of its ends.

The presence of sealing welds allows good sealing and also reduces the risk of leakage of phase-change material notably when the latter is in the liquid phase.

According to one aspect of the invention, the sealing weld is a weld between the tube and a plug.

According to another aspect of the invention, the sealing weld is produced by crushing and fusing the wall of said tube.

According to another aspect of the invention, the encapsulated phase-change material comprises, within tube, a plug arranged between the sealing weld and the phase-change material.

According to another aspect of the invention, the sealing weld has radial beads.

The present invention also relates to a thermal battery comprising an encapsulated phase-change material as described hereinabove.

The present invention also relates to a method of producing an encapsulated phase-change material comprising a phase-change material contained within a tube made of plastic, said method comprising at least a step of sealing the walls of the tube at its ends using welding.

According to one aspect of the production method of the invention, this method comprises a step of introducing a plug between the ends of the tube and the phase-change material, prior to the step of sealing by welding.

According to another aspect of the production method of the invention, the weld is produced by crushing the ends of the tube and heating the walls of said tube so as to weld these together.

According to another aspect of the production method of the invention, radial beads are formed as the tube walls are crushed and heated.

According to one aspect of the production method of the invention, the weld is produced by heating the walls of the tube so as to weld these to a plug.

Further features and advantages of the invention will become more clearly apparent from reading the following description, given by way of nonlimiting illustration, and from the appended drawings, in which:

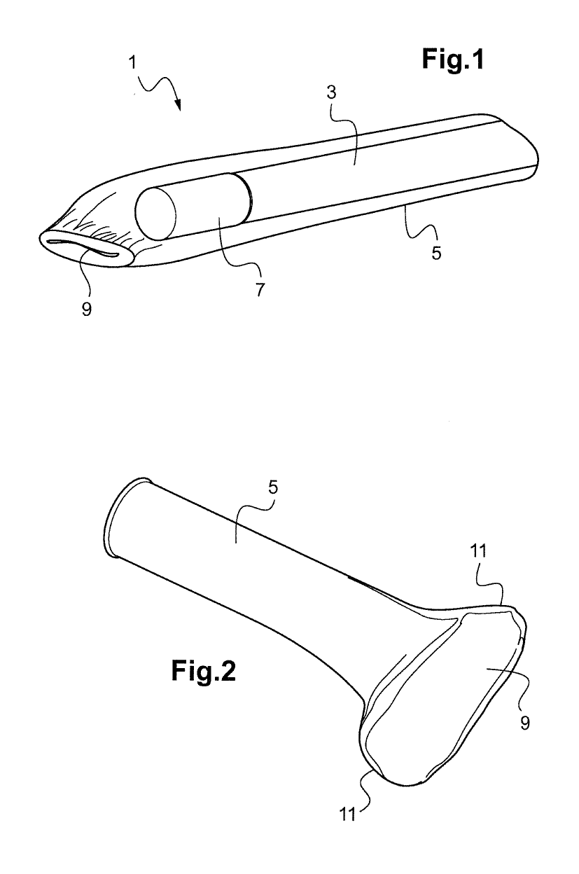

FIG. 1 is a schematic depiction of one end of a tube of encapsulated phase-change material according to a first embodiment,

FIG. 2 is a schematic depiction of one end of a tube of encapsulated phase-change material according to a second embodiment,

In the various figures, identical elements bear the same reference numbers.

The encapsulated phase-change material 1 illustrated in FIGS. 1 and 2 comprises a tube made of plastic, for example of polycarbonate. The tube 5 contains a phase-change material 3 and its ends have sealing welds 9 so as to keep said phase-change material 3 inside said tube 5. Such a tube 5 is notably used in the automotive field in thermal batteries comprising a multitude of phase-change material 3 tubes 5.

What is meant by a sealing weld is that the plastic wall of the tube 5 undergoes at least partial fusion so as to form a fluid tight seal.

The presence of sealing welds 9 allows good sealing and thus reduces the risk of leakage of phase-change material 3 notably when the latter is in the liquid phase.

According to a first embodiment illustrated in FIGS. 1 and 2, the sealing weld 9 is produced by crushing and fusing the walls of the tube 5.

In order to ensure an even greater level of sealing, it is also possible to insert a plug 7 within the tube 5 before welding the walls of the tube 5 together. The plug 7 is then positioned between the phase-change material 3 and the sealing weld 9, as shown in FIG. 1.

In this embodiment, the sealing weld 9 may have radial beads 11. In the context of a thermal battery comprising a multitude of tubes 5 of phase-change material 3, these radial beads 11 allow said tubes 5 to be spaced away from one another in order to facilitate the circulation of a fluid passing through said thermal battery.

According to a second embodiment which has not been depicted, the sealing weld 9 is a weld between the tube 5 and the plug 7.

The invention also relates to the method of producing the encapsulated phase-change material 1. The production method thus comprises at least one step of sealing the walls of the tube 5 at its ends using welding.

This step may be preceded by a step of introducing a plug 7 between the ends of the tube 5 and the phase-change material 3.

During this step of welding the walls of the tube 5 at its ends, the sealing weld 9 may thus be produced by crushing the ends of the tube 5 and heating the walls of said tube 5 so as to weld these together. During this crushing and heating the radial beads 11 are formed, notably as material creeps at the sides.

Alternatively, the sealing weld 9 may be produced by heating the walls of the tube 5 so as to weld them to the plug 7 during the step of welding the walls of the tube 5 at its ends.

Thus it may be clearly seen that the encapsulated phase-change material 1 according to the invention allows improved sealing, because of these sealing welds 9 at its ends.

1. An encapsulated phase-change material comprising:
a phase-change material contained within a tube,
wherein said tube is made of plastic, and has a sealing weld at least at one end of the tube.

2. The encapsulated phase-change material as claimed in the claim 1, wherein the sealing weld is a weld between the tube and a plug.

3. The encapsulated phase-change material as claimed in claim 1, wherein the sealing weld is produced by crushing and fusing the wall of said tube.

4. The encapsulated phase-change material as claimed in claim 3, wherein within the tube, a plug is arranged between the sealing weld and the phase-change material.

5. The encapsulated phase-change material as claimed in claim 3, wherein the sealing weld has radial beads.

6. A thermal battery, comprising an encapsulated phase-change material as claimed in claim 1.

7. A method of producing an encapsulated phase-change material comprising a phase-change material contained within a tube made of plastic, said method comprising:
at least a step of sealing the walls of the tube at its ends using welding.

8. The production method as claimed in claim 7, further comprising: a step of introducing a plug between the ends of the tube and the phase-change material, prior to the step of sealing by welding.

9. The production method as claimed in claim 7, wherein the weld is produced by crushing the ends of the tube and heating the walls of said tube so as to weld these together.

10. The production method as claimed in claim 9, wherein radial beads are formed as the walls of the tube are crushed and heated.

11. The production method as claimed in claim 7, the weld is produced by heating the walls of the tube so as to weld these to a plug.
